(19) United States
(12) Patent Application Publication
(10) Pub. No.: US 2023/0261266 A1
(43) Pub. Date: Aug. 17, 2023

(54) ELECTRODE ASSEMBLY AND SECONDARY BATTERY INCLUDING THE SAME

(71) Applicant: LG ENERGY SOLUTION, LTD., Seoul (KR)

(72) Inventor: Jin Soo KIM, Daejeon (KR)

(73) Assignee: LG ENERGY SOLUTION, LTD., Seoul (KR)

(21) Appl. No.: 18/015,789

(22) PCT Filed: Jul. 13, 2021
(86) PCT No.: PCT/KR2021/008970

§ 371 Date: Jan. 12, 2023

(30) Foreign Application Priority Data
Jul. 13, 2020 (KR) 10-2020-0085822

(51) Int. Cl. H01M 10/0587; H01M 50/46; H01M 10/04; H01M 4/04

(52) U.S. Cl. CPC H01M 10/0587; H01M 50/46; H01M 10/0431; H01M 4/0404

(57) ABSTRACT

An electrode assembly includes a first electrode; a second electrode; and a first separator interposed between the first electrode and the second electrode. The first electrode, the second electrode and the first separator are wound together to form a jelly-roll structure. The first electrode includes a first portion including an innermost edge of the first electrode near a center portion of the jelly-roll structure and a second portion extending from the first portion away from the center portion of the jelly-roll structure. A thickness of the first portion is thinner than a thickness of the second portion.

### TECHNICAL FIELD

### Cross Citation with Related Application(s)

This application claims the benefit of Korean Patent Application No. 10-2020-0085822 filed on Jul. 13, 2020 with the Korean Intellectual Property Office, the disclosure of which is incorporated herein by reference in its entirety.

The present disclosure relates to an electrode assembly and a secondary battery including the same, and more particularly, to an electrode assembly including a jelly-roll electrode assembly, and a secondary battery including the same.

### BACKGROUND

Recently, as energy source price is increasing due to the depletion of fossil fuels and increasing interest is being paid to environmental pollution, the demand for environmentally-friendly alternative energy sources is bound to play an important role in the future life. Thus, research into techniques for generating various kinds of power, such as nuclear energy, solar energy, wind energy, and tidal power, is underway, and power storage apparatuses for more efficient use of the generated energy are also drawing much attention.

In particular, with the increase of the technological development and demand for a mobile device, demand for a battery as an energy source rapidly increases, and accordingly, much research on batteries satisfying various needs has been carried out.

Typically, the demand for the lithium secondary battery, such as a lithium ion battery or a lithium ion polymer battery, which have advantages such as a high energy density, a discharge voltage, an output stability, and the like is high.

Further, based on the shape of a battery case, the secondary battery is classified into a cylindrical battery where an electrode assembly is built into a cylindrical metal can, a prismatic battery where an electrode assembly is built into a prismatic metal can, and a pouch type battery where an electrode assembly is built into a pouch type case of an aluminum laminate sheet.

Further, the secondary battery may be classified based on the structure of an electrode assembly having a structure in which a positive electrode and a negative electrode are stacked in the state in which a separator is interposed therebetween.

Typically, there may mentioned, for example, a jelly-roll (wound) type electrode assembly having a structure in which long sheets of positive electrodes and negative electrodes are wound in the state in which a separator is interposed therebetween or a stacked type electrode assembly having a structure in which pluralities of positive electrodes and negative electrodes, cut by a certain size unit, are sequentially stacked in the state in which separators are interposed therebetween.

In recent years, in order to solve problems caused by the jelly-roll type electrode assembly and the stacked type electrode assembly, there has been developed a stacked/folded type electrode assembly, which is a combination of the jelly roll type electrode assembly and the stacked type electrode assembly, having a structure in which unit cells stacked with predetermined units of the positive electrodes and the negative electrodes are sequentially wound with a separator being interposed therebetween in the state of having been placed on a separation film.

FIG. 1 is a perspective view of a conventional jelly-roll electrode assembly, FIGS. 2A and 2B are partial views showing a section “U” of FIG. 1 in an enlarged manner. In particular, FIG. 2A shows the first half of a charge/discharge cycle, and FIG. 2B shows the second half of the charge/discharge cycle repeated several hundred to several thousand times.

Referring to FIGS. 1 and 2A, a conventional jelly-roll electrode assembly may be formed by winding a positive electrode 10 and a negative electrode 20. A positive electrode tab 11 attached to the positive electrode 10 and a negative electrode tab 21 attached to the negative electrode 20 may be protruded in mutually opposite directions in the jelly-roll electrode assembly. A separator is interposed between the positive electrode 10 and the negative electrode 20, and in FIGS. 2A and 2B, the illustration of the separator has been omitted for convenience of explanation.

Referring to FIG. 2A, in the central portion C of the jelly-roll electrode assembly, there is a region where the negative electrode 20 is extended more than the positive electrode 10 and is additionally wound. That is, after the negative electrode 20 is wound to some extent, the positive electrode 10 is interposed and wound together.

In the region where only the negative electrode 20 and the separator are wound, there is almost no space generated due to the difference in thickness, etc., but as the positive electrode 10 is interposed at the starting point of the positive electrode 10, the thickness increases sharply from 100 μm to 200 μm, and a physical step is formed within the jelly-roll electrode assembly.

Due to such a step structure, the possibility of bending deformation exists, which may induce an asymmetric structure of the electrode assembly and cause a problem that the shape of the jelly-roll electrode assembly is distorted after repeated charge/discharge. Specifically, as the contraction and expansion of the negative electrode 20 are repeated according to charging and discharging, stress is concentrated on the step structure, the positive electrode 10 enter the empty space formed in the step structure, and deformation of the central portion C of the electrode assembly may occur.

Further, referring to FIG. 2B, after the charge/discharge cycle repeated several hundred to several thousand times is performed, lithium precipitates P may be formed on the surface of the negative electrode 20 facing the positive electrode 10. At this time, since a chemical reaction does not occur in the region where only the negative electrode 20 and the separator are wound, a lithium precipitate P is not formed on the surface of the negative electrode 20. However, since a chemical reaction occurs from the region where the positive electrode 10 is interposed, a lithium precipitate P may be formed on the surface of the negative electrode 20. As a result, the step structure may be formed larger by the lithium precipitate P formed as the charge and discharge are repeated. As the expansion of the jelly-roll electrode assembly and the increase in the step structure are accelerated by the lithium precipitate P, a bending stress can be maximized in the negative electrode 20. When the stress due to the step structure exceeds the elongation limit of the negative electrode 20 in the process of repeating contraction and expansion of the negative electrode 20, eventually, cracks may occur, leading to disconnection or short circuit, which may greatly impair the safety of the secondary battery.

### DETAILED DESCRIPTION OF THE INVENTION

### Technical Problem

It is an object of the present disclosure to provide an electrode assembly that improves the safety by resolving stress concentration caused by the step structure, and a secondary battery including the same.

However, the problem to be solved by the embodiments of the present disclosure is not limited to the above-described problems, and can be variously expanded within the scope of the technical idea included in the present disclosure.

### Technical Solution

According to one embodiment of the present disclosure, there is provided an electrode assembly comprising: a first electrode; a second electrode; and a first interposed between the first electrode and the second electrode, wherein the first electrode, the second electrode and the first separator are wound together to form a jelly-roll structure, wherein the first electrode comprises a first portion including an innermost edge of the first electrode near a center portion of the jelly-roll structure and a second portion extending from the first portion away from the center portion of the jelly-roll structure, and wherein a thickness of the first portion is thinner than a thickness of the second portion.

An innermost edge of the second electrode may be located closer to the center portion of the jelly-roll structure than the innermost edge of the first electrode is located to the center portion of the jelly-roll structure.

In the center portion of the jelly-roll structure, the second electrode is wound to extend past the first electrode.

The first electrode may be a positive electrode, and the second electrode may be a negative electrode.

The first portion may be wound 0.5 times or more and 1.5 times or less of a winding circumference at the center portion of the jelly-roll structure.

A thickness of the first portion may be 0.4 times or more and 0.8 times or less than a thickness of the second portion.

The first electrode may further include a third portion located between the first portion and the second portion, and a thickness of the third portion may gradually decrease from the second portion to the first portion.

The first electrode may include an electrode current collector and an active material layer formed on the electrode current collector.

A thickness of the electrode current collector at the first portion may be thinner than a thickness of the electrode current collector at the second portion.

A thickness of the active material layer at the first portion may be thinner than a thickness of the active material layer at the second portion.

An application amount of the electrode active material per unit area of the active material layer at the first portion may be smaller than an application amount of the electrode active material per unit area of the active material layer at the second portion.

The electrode assembly may further include a second separator located such that the second electrode is disposed between the first separator and the second separator.

### Advantageous Effects

According to the embodiments of the present disclosure, the thickness of the starting portion of the electrode wound in the electrode assembly is set thin, whereby the structural adverse effect due to the step can be minimized, and the safety of the secondary battery can be improved.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a conventional jelly-roll electrode assembly;

FIGS. 2A and 2B are partial views showing a section “U” of FIG. 1 in an enlarged manner;

FIG. 3 is a perspective view of an electrode assembly according to an embodiment of the present disclosure;

FIG. 4 is an exploded perspective view showing a state before the electrode assembly of FIG. 3 is wound up;

FIG. 5 is a partial view showing a section “V” of FIG. 3 in an enlarged manner;

FIG. 6 is a partial view showing a section “W” of FIG. 4 in an enlarged manner;

FIG. 7 is a partial view for explaining a first portion to a third portion according to another embodiment of the present disclosure; and

FIG. 8 is a schematic diagram for explaining a method of forming a first portion of a first electrode according to an embodiment of the present disclosure.

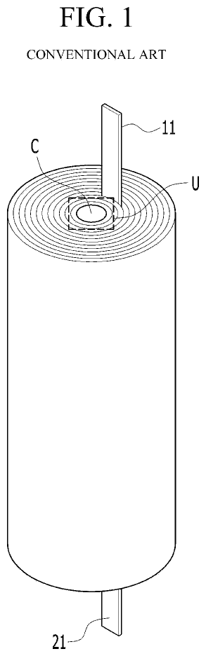

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

A description of parts not related to the description will be omitted herein for clarity, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

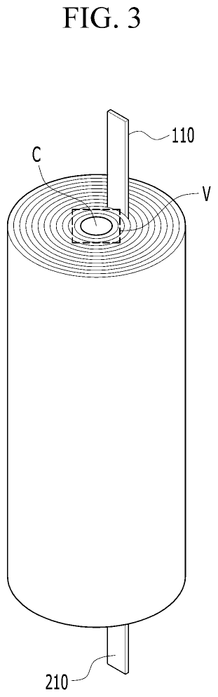

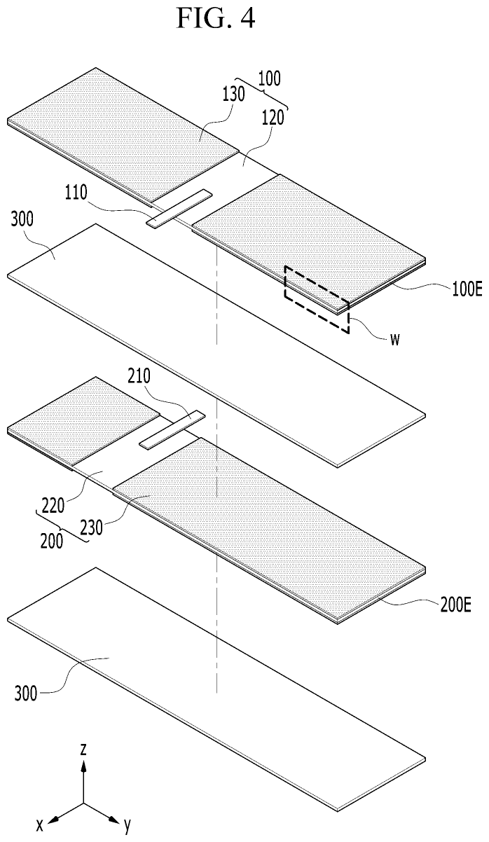

FIG. 3 is a perspective view of an electrode assembly according to an embodiment of the present disclosure, and FIG. 4 is an exploded perspective view showing a state before the electrode assembly of FIG. 3 is wound up.

Referring to FIGS. 3 and 4, the electrode assembly according to one embodiment of the present disclosure includes a first electrode 100, a second electrode 200, and a separator 300 interposed between the first electrode 100 and the second electrode 200, wherein the first electrode 100, the second electrode 200 and the separator 300 are wound together to form a jelly-roll structure. In order to prevent the first electrode 100 and the second electrode 200 from coming into contact with each other when forming the jelly-roll structure, it is preferable that the separator 300 is additionally disposed under the second electrode 200.

The first electrode 100 may include an electrode current collector 120 of a thin metal plate and an active material layer 130 formed on the electrode current collector 120. The active material layer 130 may be formed by applying an electrode active material onto the electrode current collector 120. Further, after exposing a part of the electrode current collector 120 without applying the active material, a first electrode tab 110 can be joined.

Similarly, the second electrode 200 may include the electrode current collector 220 of a thin metal plate and the active material layer 230 formed on the electrode current collector 220. Such an active material layer 230 can be formed by applying the electrode active material onto the electrode current collector 220. Further, after exposing a part of the electrode current collector 220 without applying an active material, a second electrode tab 210 can be joined.

The first electrode tab 110 and the second electrode tab 210 may be protruded in mutually opposite directions with respect to the electrode assembly of the jelly-roll structure.

On the other hand, the first electrode 100 may be a positive electrode formed by applying a positive electrode active material onto the electrode current collector 120, and the second electrode 200 may be a negative electrode formed by applying a negative active material onto the electrode current collector 220.

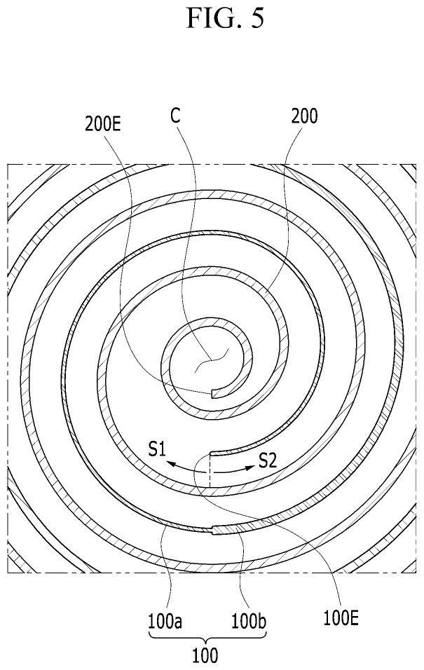

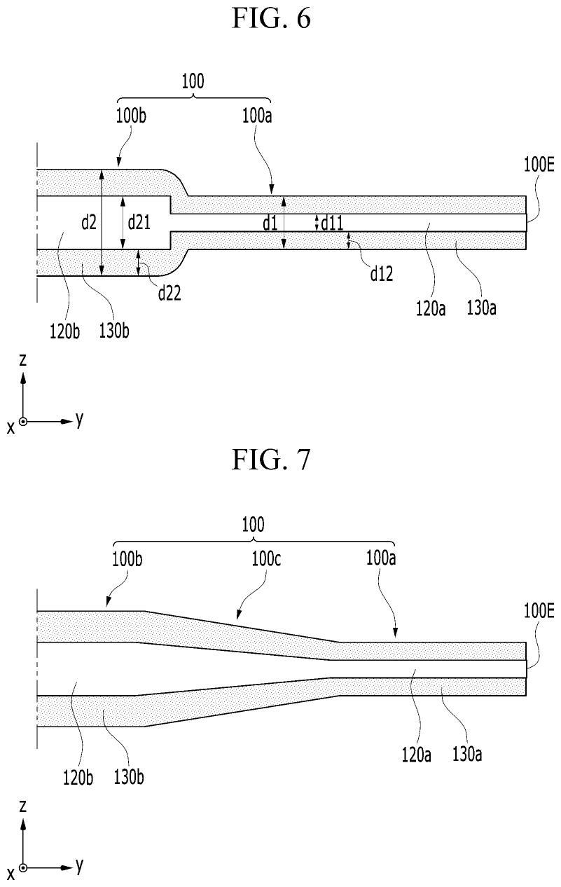

Next, the first portion and the second portion included in the first electrode will be described with reference to FIGS. 5 and 6.

FIG. 5 is a partial view showing a section “V” of FIG. 3 in an enlarged manner. FIG. 6 is a partial view showing a section “W” of FIG. 4 in an enlarged manner. Particularly, in FIG. 5, the illustration of the separator 300 interposed between the first electrode 100 and the second electrode 200 has been omitted for convenience of explanation.

Referring to FIGS. 5 and 6, the first electrode 100 according to the present embodiment includes a first portion 100a including an innermost edge 100E of the first electrode 100 and a second portion 100b extending from the first portion 100a, on the basis of the jelly-roll structure, and a thickness d1 of the first portion 100a is thinner than a thickness d2 of the second portion 100b. Further, the innermost edge 200E of the second electrode 200 may be located closer to the center portion C of the jelly-roll structure than the innermost edge 100E of the first electrode 100, on the basis of the jelly-roll structure.

Here, the central portion (C) of the jelly-roll structure is the center portion of a circular structure when the jelly-roll structure is viewed from above, and refers to a virtual region corresponding to the portion where the winding starts. Further, the innermost edge 100E of the first electrode 100 and the innermost edge 200E of the second electrode 200 mean an edge on one side where winding starts first at the first electrode 100 and the second electrode 200.

Specifically, in the central portion C of the jelly-roll structure, the second electrode 200 may be wound to extend from the first electrode 100. That is, after the second electrode 200 and the separator 300 are first wound to some extent, the first electrode 100 may be interposed and wound together. As described above, the first electrode 100 and the second electrode 200 may be a positive electrode and a negative electrode, respectively. However, in the chemical reaction of a lithium ion battery, since the negative electrode must receive lithium ions from the positive electrode, it is preferable that the negative electrode is designed to be wider in length and width than the positive electrode. If the length or width of the positive electrode is formed wider, the space for receive lithium ions becomes deficient, and so charge and discharge cannot be carried out smoothly, and the risk of explosion may increase. Therefore, it is preferable that the second electrode 200, which is a negative electrode, is wound earlier than the first electrode 100, which is a positive electrode, at the center portion C where the winding of the jelly-roll electrode assembly starts. In one example, after the second electrode 200 is wound about one to two times earlier than the first electrode 100, the first electrode 100 may be interposed therebetween. Thereby, as described above, the innermost edge 200E of the second electrode 200 is located closer to the center portion C of the jelly-roll structure than the innermost edge 100E of the first electrode 100, on the basis of the jelly-roll structure. Further, although not specifically shown in the figure, the second electrode 200, which is a negative electrode, may be extended and formed to sufficiently cover the first electrode 100, which is a positive electrode, even on the outer peripheral surface of the jelly-roll electrode assembly to which winding is finished.

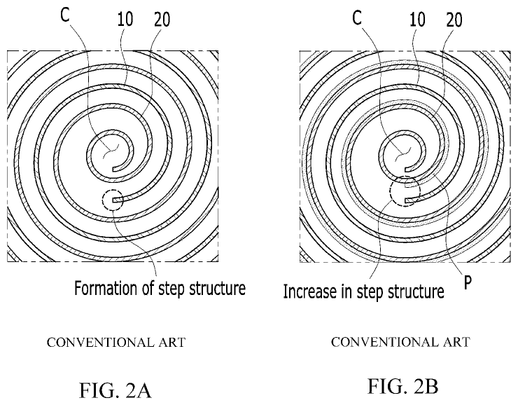

In the case of the conventional electrode assembly described with reference to FIGS. 2A and 2B, as the positive electrode 10 is interposed at the starting point of the positive electrode 10, a step structure is formed, stress is concentrated on the step structure, which may eventually cause problems such as cracks, disconnections or short circuits. In particular, after repeated charge/discharge cycles, the short-circuit structure may become large due to lithium precipitates P formed on the surface of the negative electrode 20. Thus, the above problems may become more serious according to the progress of charge/discharge.

On the other hand, the electrode assembly according to the present embodiment can minimize the problem caused by the step structure by forming the thickness d1 of the first portion 100a including the innermost edge 100E of the first electrode 100 thinner than the thickness d2 of the second portion 100b. In other words, by providing the first portion 100a, it is possible to reduce a change in the thickness of the starting point of the first electrode, that is, the portion wound from the innermost side. Thereby, the bending stress due to the step structure can be reduced, so that the occurrence of cracks, disconnections, short circuits, etc. can be prevented. More specifically, in the region S1 before the innermost edge 100E, that is, before the first electrode 100 is interposed, the first electrode 100 is located only on one surface of the second electrode 200, and charge and discharge from the first electrode 100 are performed only on one surface of the second electrode 200. On the other hand, in the region S2 after the first electrode 100 is interposed, the first electrode 100 is located on both surfaces of the second electrode 200, whereby charge and discharge from the first electrode 100 are performed on both surfaces of the second electrode 200. Therefore, the innermost edge 100E of the first electrode 100 can be seen as a boundary between a region charged/discharged on one side and a region charged/discharged on both sides, so that the step becomes deeper based on the boundary, and stress can be maximized. The first portion 100a according to the present embodiment is designed to be thin in thickness, and an attempt is made to maximize the reduction of such a step structure and the above-mentioned problems caused by the structure.

Further, the degree of contraction and expansion of the second electrode 200 due to the repetition of the charge/discharge cycle via the first portion 100a is reduced, and thus the possibility of occurrence of cracks or disconnections can be further reduced. As described above, the second electrode 200 may be a negative electrode, and the above-mentioned effect can be more remarkable when applied to a high-capacity cell with a large content of SiO in the negative electrode.

Meanwhile, the first portion 100a may be wound 0.5 or more and 1.5 or less times in the jelly-roll structure. When the first portion 100a is wound less than 0.5 times, the step structure induced by the first electrode 100 cannot be properly relaxed, which is not effective in reducing stress. Further, when the first portion 100a is wound more than 1.5 times, the region of the first portion 100a may be formed more than necessary, which may cause a problem that the battery capacity and the output are not good. In FIG. 5, a state in which the first portion 100a is wound once is shown as an example.

Meanwhile, the thickness d1 of the first portion 100a may be 0.4 times or more and 0.8 times or less the thickness d2 of the second portion 100b. When the thickness d1 of the first portion 100a is less than 0.4 times the thickness d2 of the second portion 100b, a step structure is rather formed between the first portion 100a and the second portion 100b, which is not preferable. Further, when the thickness d1 of the first portion 100a is greater than 0.8 times the thickness d2 of the second portion 100b, it may difficult to properly relax the step structure formed by the innermost edge 100E of the interposed first electrode 100.

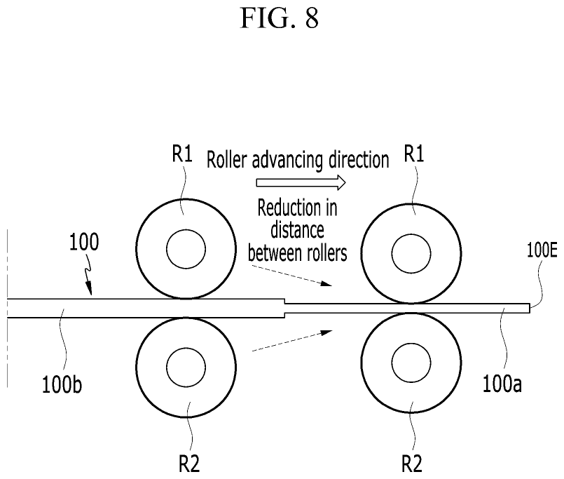

Referring back to FIG. 6, the first electrode 100 may include an electrode current collector 120 and an active material layer 130 as described above. At this time, the thickness d11 of the electrode current collector 120a of the first portion 100a may be thinner than the thickness d21 of the electrode current collector 120b of the second portion 100b. Further, the thickness d12 of the active material layer 130a of the first portion 100a may be thinner than the thickness d22 of the active material layer 130b of the second portion 100b. That is, when forming the thickness of the first portion 100a to be thinner than the thickness of the second portion 100b, it is possible to form a thickness difference between the electrode current collectors 120a and 120b, or to form a thickness difference between the active material layers 130a and 130b. Of course, it is also possible to form both the thickness differences between the electrode current collectors 120a and 120b and between the active material layers 130a and 130b. The method of forming such a thickness difference is not particularly limited, but distance adjustment using a roller press may be used. This point will be described again together with FIG. 8 below.

Meanwhile, the application amount of the electrode active material per unit area of the active material layer 130a of the first portion 100a may be smaller than the application amount of the electrode active material per unit area of the active material layer 130b of the second portion 100b. Here, the application amount of the electrode active material per unit area means the amount of the electrode active material applied relative to the area of the surface (a surface parallel to the xy plane) of the electrode current collectors 120a and 120b to which the electrode active material is applied. According to the present embodiment, when forming the thickness difference between the active material layers 130a and 130b, it is possible to impart a difference in the amount of the active material applied. In other words, the loading amount of the electrode active material in the first portion 100a may be set to be smaller than the loading amount of the electrode active material in the second portion 100b. Therefore, not only the thickness d12 of the active material layer 130a of the first portion 100a may be formed thinner than the thickness d22 of the active material layer 130b of the second portion 100b, but also when the second electrode 200 is the negative electrode, the loading amount is small, so that the possibility of lithium precipitation on the negative electrode having a large curvature can be reduced. Therefore, it may be more effective to relax the step structure described above.

Next, a third portion according to another embodiment of the present disclosure will be described in detail with reference to FIG. 7.

FIG. 7 is a partial view for explaining a first portion to a third portion according to another embodiment of the present disclosure. In detail, it is a partial view of a portion corresponding to FIG. 6.

Referring to FIG. 7, the first electrode 100 according to the present embodiment further includes a third portion 100c located between the first portion 100a and the second portion 100b, and the thickness of the third portion 100c may gradually decrease as progressing toward the first portion 100a from the second portion 100b.

According to the present embodiment, by providing a third portion 100c that forms a smooth surface and gradually decreases in thickness, the sudden thickness deviation can be removed, whereby the step at the portion where the winding of the first electrode 100 starts can be further reduced. Further, according to the present embodiment, the area of the first portion 100a is reduced and the area of the third portion 100c is made wider, whereby the empty space in the step structure and the jelly roll structure resulting therefrom can be significantly reduced.

FIG. 8 is a schematic diagram for explaining a method of forming a first portion of a first electrode according to an embodiment of the present disclosure.

Referring to FIG. 8, when the first electrode 100 is passed between the first roller R1 and the second roller R2 each located above and below the first electrode 100, the distance between the first roller R1 and the second roller R2 is adjusted, so that the first portion 100a can be provided on the first electrode 100.

Specifically, the distance between the first roller R1 and the second roller R2 when compressing the first portion 100a can be set narrower than the distance between the first roller R1 and the second roller R2 when compressing the second portion 100b. In addition, the distance between the first roller R1 and the second roller R2 is set to be gradually narrowed, so that the third portion 100c shown in FIG. 7 may be formed between the first portion 100a and the second portion 100b. If the distance between the first roller R1 and the second roller R2 is adjusted, the subject of movement is not particularly limited. In other words, in addition to moving the first roller R1 and the second roller R2 in the left and right directions along the first electrode 100, a method in which the first electrode 100 moves with respect to the fixed first roller R1 and the second roller R2 in the left and right directions is also possible.

Although the terms representing directions such as front, rear, left, right, upper and lower directions are used herein, it would be obvious to those skilled in the art that these merely represent for convenience of explanation, and may differ depending on a position of an observer, a position of an object, or the like.

The electrode assembly according to the present embodiment described above may be housed in a battery case together with an electrolyte solution to form a secondary battery, and the secondary battery can be applied to various devices. Such a device can be applied to a vehicle means such as an electric bicycle, an electric vehicle, or a hybrid vehicle, but the present disclosure is not limited thereto, and is applicable to various devices that can use a secondary battery.

Although preferred embodiments of the present disclosure have been described in detail above, the scope of the present disclosure is not limited thereto, and various modifications and improvements made by those skilled in the art using the basic concepts of the present disclosure, which are defined in the appended claims, also belong to the scope of the present disclosure.

1. An electrode assembly comprising:
a first electrode;
a second electrode; and
a first separator interposed between the first electrode and the second electrode,
wherein the first electrode, the second electrode and the first separator are wound together to form a jelly-roll structure,
wherein the first electrode comprises a first portion including an innermost edge of the first electrode near a center portion of the jelly-roll structure and a second portion extending from the first portion away from the center portion of the jelly-roll structure, and
wherein a thickness of the first portion is thinner than a thickness of the second portion.

2. The electrode assembly according to claim 1, wherein:
an innermost edge of the second electrode is located closer to the center portion of the jelly-roll structure than the innermost edge of the first electrode is located to the center portion of the jelly-roll structure.

3. The electrode assembly according to claim 1, wherein:
in the center portion of the jelly-roll structure, the second electrode is wound to extend from past the first electrode.

4. The electrode assembly according to claim 1, wherein:
the first electrode is a positive electrode, and the second electrode is a negative electrode.

5. The electrode assembly according to claim 1, wherein:
the first portion is wound 0.5 times or more and 1.5 times or less of a winding circumference at the center portion of the jelly-roll structure.

6. The electrode assembly according to claim 1, wherein:
a thickness of the first portion is 0.4 times or more and 0.8 times or less than a thickness of the second portion.

7. The electrode assembly according to claim 1, wherein:
the first electrode further comprises a third portion located between the first portion and the second portion, and
a thickness of the third portion gradually decreases from the second portion to the first portion.

8. The electrode assembly according to claim 1, wherein:
the first electrode comprises an electrode current collector and an active material layer formed on the electrode current collector.

9. The electrode assembly according to claim 8, wherein:
a thickness of the electrode current collector at the first portion is thinner than a thickness of the electrode current collector at the second portion.

10. The electrode assembly according to claim 8, wherein:
an application amount of the electrode active material per unit area of the active material layer at the first portion is smaller than an application amount of the electrode active material per unit area of the active material layer at the second portion.

11. A secondary battery comprising the electrode assembly as set forth in claim 1.

12. The electrode assembly according to claim 9, wherein:
a thickness of the active material layer at the first portion is thinner than a thickness of the active material layer at the second portion.

13. The electrode assembly according to claim 1, further comprising a second separator located such that the second electrode is disposed between the first separator and the second separator.
